(19) United States
(12) Patent Application Publication
(10) Pub. No.: US 2021/0401049 A1
(43) Pub. Date: Dec. 30, 2021

(54) HIGH-FREQUENCY HEATING DEVICE

(71) Applicant: Shenzhen Eigate Technology Co., Ltd., Shenzhen (CN)

(72) Inventor: Tuanfang LIU, Shenzhen (CN)

(21) Appl. No.: 17/128,178

(22) Filed: Dec. 20, 2020

(30) Foreign Application Priority Data
Jun. 29, 2020 (CN) 202010607065.8
Jun. 29, 2020 (CN) 202021230412.1

(51) Int. Cl. A24F 40/465; H05B 6/10; H05B 6/04; A24F 40/20; A24F 40/57; A24F 1/30; A24F 5/00

(52) U.S. Cl. CPC A24F 40/465; H05B 6/105; H05B 6/04; H05B 6/36; A24F 40/57; A24F 1/30; A24F 5/00; A24F 40/20

(57) ABSTRACT

A high-frequency heating device includes a heating cup and a magnetic induction coil. The magnetic induction coil is a curved structure.

### CROSS-REFERENCE TO RELATED APPLICATIONS

Pursuant to 35 U.S.C. § 119 and the Paris Convention Treaty, this application claims foreign priority to Chinese Patent Application No. 202010607065.8 filed on Jun. 29, 2020, and to Chinese Patent Application No. 202021230412.1 filed on Jun. 29, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a high-frequency heating device.

Conventionally, a high-frequency heating device comprises a magnetic induction coil. The magnetic induction coil is made of copper and is in the shape of a hollow cylindrical spiral.

### SUMMARY

The disclosure provides a high-frequency heating device, comprising a heating cup and a magnetic induction coil; the magnetic induction coil is a curved structure.

In a class of this embodiment, the magnetic induction coil is a curved square vertically disposed with respect to the heating cup; and the heating cup is attached to a concave surface of the magnetic induction coil.

In a class of this embodiment, the heating cup comprises glass with an inlaid metal.

In a class of this embodiment, the magnetic induction coil is a coiled copper wire coated with an insulating high temperature resistant material.

In a class of this embodiment, the device further comprises an upper cover and a lower cover; the heating cup and the magnetic induction coil are disposed in a space formed by the upper cover and the lower cover.

In a class of this embodiment, the upper cover comprises an opening communicating with the heating cup and a tobacco material is added to the heating cup via the opening.

In a class of this embodiment, the device further comprises a high-frequency control panel and a battery disposed in the space formed by the upper cover and the lower cover; the battery is soldered on an input end of the high-frequency control panel; an output end of the high-frequency control panel is soldered on an input end of the magnetic induction coil to supply alternating voltage and alternating current for the magnetic induction coil whereby an alternating magnetic field is formed in the magnetic induction coil.

The disclosure also provides an electronic cigarette, comprising the high-frequency heating device.

In a class of this embodiment, the electronic cigarette further comprises a smoke filter configured to filter smoke or vapor in water for user's inhaling.

### BRIEF DESCRIPTION OF THE DRAWINGS

FIG. 1 is an exploded view of a high-frequency heating device in accordance with one embodiment of the disclosure;

FIG. 2 is a schematic diagram of a high-frequency heating device in accordance with one embodiment of the disclosure; and

FIG. 3 is a sectional view of a high-frequency heating device in accordance with one embodiment of the disclosure.

### DETAILED DESCRIPTION

To further illustrate, embodiments detailing a high-frequency heating device are described below. It should be noted that the following embodiments are intended to describe and not to limit the disclosure.

Principle of high frequency heating: when an alternating current is introduced to a magnetic induction coil, an alternating magnetic field will be generated. When a metal conductor is placed in the alternating magnetic field, an eddy current is produced. The eddy current makes the metal conductor heated.

Tobacco materials refer to tobacco tar, tobacco paste, tobacco leaf and other materials used to produce smoke.

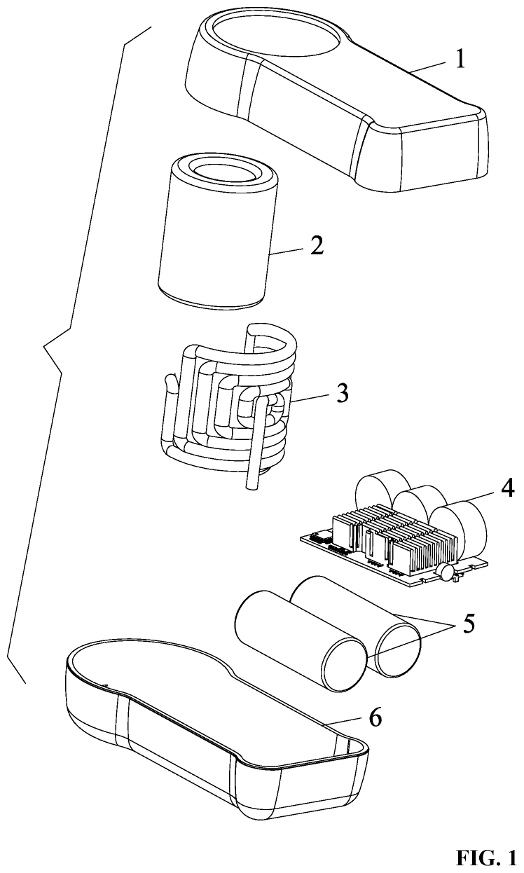

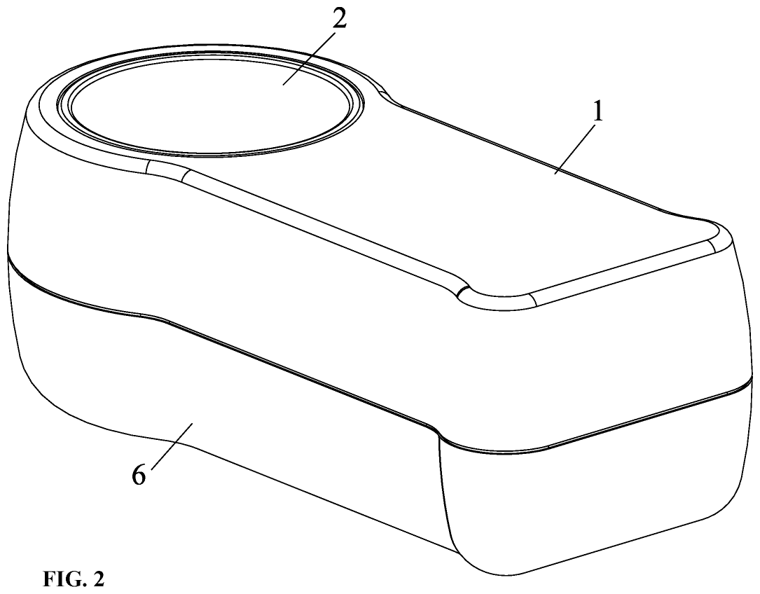

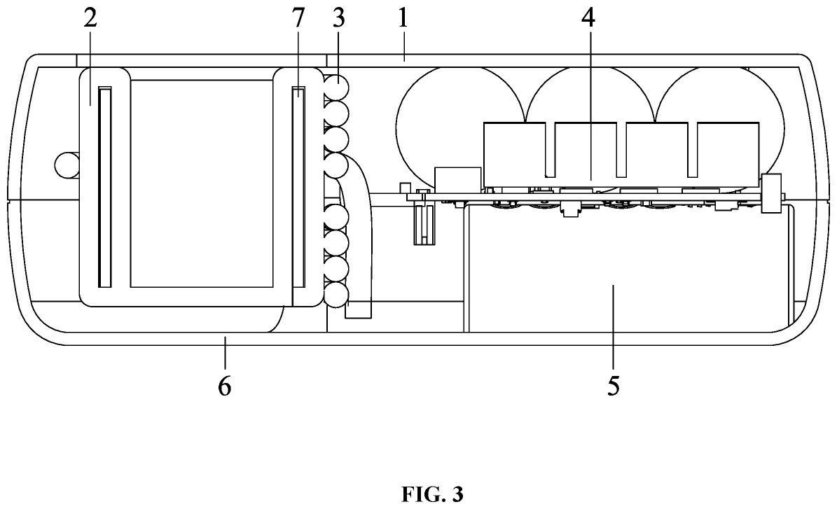

As shown in FIGS. 1-3, the disclosure provides an upper cover 1, a heating cup 2, a magnetic induction coil 3, a high-frequency control panel 4, a battery 5, and a lower cover 6. The heating cup 2 comprises an insulating high temperature resistant glass with an inlaid metal 7, so that the metal 7 is in non-contact with the magnetic induction coil 3 thus preventing the electric leakage of the magnetic induction coil 3. The magnetic induction coil 3 is a curved square structure comprising a coiled copper wire and is coated with an insulating high temperature resistant material. The heating cup 2 is configured to accommodate a tobacco material and is attached to the concave surface of the magnetic induction coil 3. The heating cup 2, the magnetic induction coil 3, the high-frequency control panel 4, and the battery 5 are disposed in a space formed by the upper cover 1 and the lower cover 6. The upper cover 1 comprises an opening communicating with the heating cup 2 and the tobacco material is added to the heating cup via the opening. The upper cover 1 and the lower cover 6 are polymer materials with thermal insulation and electric insulation properties. The battery 5 is soldered on the input end of the high-frequency control panel 4. The output end of the high-frequency control panel 4 is soldered on the input end of the magnetic induction coil 3 to supply alternating voltage and alternating current for the magnetic induction coil 3 whereby an alternating magnetic field is formed in the magnetic induction coil 3. Thus, an eddy current is produced in the heating cup 2 placed in the alternating magnetic field and heat is produced. In this way, the tobacco material in the heating cup is heated.

In certain embodiments, the heating cup 2 is made of metal or non-metallic graphite with good conductivity, or quartz, crystal, mica and jade with an inlaid metal or non-metallic graphite. The magnetic induction coil 3 is a circle, triangle, quadrilateral, or polygon comprising a curved surface. The upper cover 1 and the lower cover 6 are nonmetal materials with thermal insulation and electric insulation properties.

The high-frequency heating device of the disclosure is used in an electronic cigarette, or used in an electronic hookah where the smoke or vapor is filtered in water.

The following advantages are associated with the high-frequency heating device of the disclosure:

1. The tobacco material is heated through magnetic induction.

2. The metal is inlaid in the heating cup, and thus the produced smoke or vapor does not contact the metal, which is healthy for user's inhaling.

3. The magnetic induction coil is a curved square structure comprising a coiled copper wire. The design is novel.

It will be obvious to those skilled in the art that changes and modifications may be made, and therefore, the aim in the appended claims is to cover all such changes and modifications.

What is claimed is:

1. A high-frequency heating device, comprising a heating cup and a magnetic induction coil, wherein the magnetic induction coil is a curved structure.

2. The device of claim 1, wherein the magnetic induction coil is a curved square vertically disposed with respect to the heating cup; and the heating cup is attached to a concave surface of the magnetic induction coil.

3. The device of claim 2, wherein the heating cup comprises glass with an inlaid metal.

4. The device of claim 3, wherein the magnetic induction coil is a coiled copper wire coated with an insulating high temperature resistant material.

5. The device of claim 4, further comprising an upper cover and a lower cover; wherein the heating cup and the magnetic induction coil are disposed in a space formed by the upper cover and the lower cover.

6. The device of claim 5, wherein the upper cover comprises an opening communicating with the heating cup and a tobacco material is added to the heating cup via the opening.

7. The device of claim 6, further comprising a high-frequency control panel and a battery disposed in the space formed by the upper cover and the lower cover, wherein the battery is soldered on an input end of the high-frequency control panel; an output end of the high-frequency control panel is soldered on an input end of the magnetic induction coil to supply alternating voltage and alternating current for the magnetic induction coil whereby an alternating magnetic field is formed in the magnetic induction coil.

8. An electronic cigarette, comprising the high-frequency heating device of claim 1.

9. The electronic cigarette of claim 8, further comprising a smoke filter configured to filter smoke or vapor in water for user's inhaling.
